(19) United States
(12) Patent Application Publication
(10) Pub. No.: US 2026/0054401 A1
(43) Pub. Date: Feb. 26, 2026

(54) ELECTRIC BEARD TRIMMER

(71) Applicant: Braun GmbH, Kronberg (DE)

(72) Inventors: Gerd LASCHINSKI, Bad Homburg (DE); Markus SCHUESSLER, Koenigstein (DE); Sebastian HEINRICH, Bartholomae (AT)

(21) Appl. No.: 19/305,855

(22) Filed: Aug. 21, 2025

(30) Foreign Application Priority Data
Aug. 21, 2024 (EP) 24195691.1

(51) Int. Cl. B26B 19/20

(52) U.S. Cl. CPC B26B 19/20

(57) ABSTRACT

The present invention relates to a hair cutter such as a trimmer, comprising an elongated handle, a cutter head attached to an end portion of said handle and including at least one cutting element, and a comb support structure for supporting a distance comb, wherein an adjustment wheel is provided for adjusting a position of said distance comb relative to said at least one cutting element, said adjustment wheel being rotatably supported about a rotation axis extending transverse to a direction of adjusting the comb position, wherein a transmitter is provided for translating rotatory movement of said adjustment wheel into adjusting movements, wherein said adjustment wheel and/or said transmitter are configured to provide for different transmission ratios for different rotatory positions of the adjustment wheel.

### FIELD OF THE INVENTION

The present invention relates to cutting body hair such as beard stubbles of multidays' beard. More particularly, the present invention relates to a hair cutter such as a trimmer, comprising an elongated handle, a cutter head attached to an end portion of said handle and including at least one cutting element, and a comb support structure for supporting a distance comb, wherein an adjustment wheel is provided for adjusting a position of said distance comb relative to said at least one cutting element, said adjustment wheel being rotatably supported about a rotation axis extending transverse to a direction of adjusting the comb position, wherein a transmitter is provided for translating rotatory movement of said adjustment wheel into adjusting movements.

### BACKGROUND OF THE INVENTION

Electric shavers and trimmers utilize various mechanisms to provide hair cutting functionality. Some electric shavers include a perforated shear foil cooperating with an undercutter movable relative thereto so as to cut hairs entering the perforations in the shear foil. Such shear foil type shavers are often used on a daily basis to provide for a clean shave wherein short beard stubbles are cut immediately at the skin surface.

On the other hand, other cutter systems including a pair of cooperating comb-like cutting elements with a plurality of comb-like or rake-like cutting teeth reciprocating or rotating relative to each other, are often used for cutting longer beard stubbles or curled body hair in intimate body regions or more generally, body hair being too long for shaving with a shear foil system. The teeth of such comb-like or rake-like cutting elements usually project substantially parallel to each other or substantially radially, depending on the type of driving motion, and may cut hairs entering into the gaps between the cutting teeth, wherein cutting or shearing is achieved in a scissor-like way when the cutting teeth of the cooperating elements close the gap between the finger-like cutting teeth and pass over each other.

Such cutter systems for longer hairs may be integrated into electric shavers or trimmers which at the same time may be provided with the aforementioned shear foil cutters. For example, the comb-like cutting elements may be arranged between a pair of shear foil cutters or may be arranged at a separate, extendable long hair cutter. On the other hand, there are also electric shavers or trimmers or styling apparatus which are provided only with such comb-like cutting elements.

So as to keep the cutting elements away from the skin at a certain distance therefrom, a distance comb may be attached to the cutter head, wherein such distance comb may include a plurality of ribs that may extend substantially parallel to a preferred or natural direction of movement of the cutter head over the skin. For example, for the aforementioned rake-like cutting elements for cutting longer hairs in a scissor-like way, the ribs of the distance comb may be oriented perpendicular to the row of teeth of such rake-like cutting elements. Such distance combs may be used to control the length of the hair remaining on the skin after cutting, wherein, e.g., a distance comb with ribs defining a skin contact surface 3 mm away from the rake-like cutting elements may be used for achieving a haircut leaving hairs of 3 mm length on the skin. On the other hand, such distance combs are also used for protecting sensitive skin against irritations such as nicks, cuts or abrasion when the hair cutter is used by less experienced users. For example, such distance comb is a helpful protector when using the hair cutter to cut hair in intimate regions of a body having very soft and sensitive skin that tends to easily get into the cutting elements.

So as to avoid replacement of a specific distance comb by another one to vary the distance of the comb's skin contact surface from the cutting elements, it already has been suggested to have the distance comb mounted to the cutter head in an adjustable way to vary the distance between the cutting elements and the comb's skin contact surface. Generally, adjusting such distance may be achieved by displacement of the comb in a direction perpendicular to the skin contact surface defined by the comb's ribs. Depending on the cutter head and the contour of the cutting elements, such adjustment direction may be substantially parallel to the longitudinal axis of the handle or inclined thereto at an acute angle when the cutter head's cutting elements are inclined relative to the handle's longitudinal axis. More particularly, when using the hair cutter without such distance comb, the cutter head itself, in particular a shear foil or a surface of the rake-like cutter elements or a surface of a surrounding frame may define the skin contact surface with which the hair cutter is put onto the skin to be shaved or having hair to be cut. When a distance comb is attached, the ribs usually define a skin contact surface substantially parallel to the cutter head's “own” skin contact surface without comb. The aforementioned direction of adjustment is usually, as mentioned, substantially perpendicular to the skin contact surface of the distance comb and thus, may be substantially perpendicular to the cutter head's skin contact surface without comb.

So as to control such adjusting movements of the distance comb, it already has been suggested to provide an adjustment ring surrounding the handle at a portion close to its neck neighboring the cutter head so such ring forms a ring-like portion of the handle, wherein such ring may be rotated about the handle's longitudinal axis or about a rotation axis parallel to the direction of adjustment of the comb which may be slightly inclined to the handle's longitudinal axis as mentioned above. Rotation of the ring may be translated into adjusting movements of the comb by means of a screw-like transmitter structure. For example, the ring may be provided with a circumferential slot having a thread pitch like a screw in which slot a pin connected to the comb or a comb holder is received, or in the alternative by means of a cam contour forming part of the ring and a cam follower to be placed on said cam contour and attached to the comb or a comb holder.

However, such adjustment rings are a bit disadvantageous in terms of handling and control. In particular, when the handle is gripped like a flute by a flutist, as it is often done when haircutting in difficult situations to achieve more control, such adjustment ring hardly can be turned during haircutting. Furthermore, as the adjustment ring needs some friction or resistance to be able to hold a desired position, it is usually necessary to have the handle gripped by one hand and adjust the ring by the other hand to overcome such friction. Aside from such handling problems, the adjustment ring usually interferes with the support structure for supporting the distance comb. As it is desired to have the distance comb replaceable, for example for cleaning or for using the haircutter without comb, the support structure is usually arranged on an outer surface of the cutter head and/or of the handle, wherein the support structure needs some length to provide for the adjustment range and for sufficient stiffness so the support structure may extend where it would be desired to have the adjustment ring positioned.

So as to avoid such problems of adjustment rings having a rotation axis parallel to the desired direction of adjusting the comb, an alternative type of adjustment device having an alternative kinematic has been suggested. More particularly, such alternative adjustment device includes an adjustment wheel supported rotatably about a rotation axis that extends substantially perpendicular to the desired direction of adjusting the distance comb. Such orientation of the adjustment wheel allows for placing the adjustment wheel and more particularly, a turning knob portion thereof, onto and tangential to an outer contour of the handle, wherein only one side of the handle is needed for such adjustment wheel and its turning knob portion. More particularly, the adjustment wheel may be arranged, e.g., on a front side of the handle where other control elements may be provided such as the ON/OFF-switch for switching on and off a motor, or a display for displaying information like battery charging status. In the alternative, it also would be possible to have such adjustment wheel on a back side of the handle. In any case, such adjustment wheel does not obstruct an entire ring section going around the circumference of the handle.

So as to translate the adjustment wheel's rotation into the desired adjusting movement of the comb or a comb holder which may be a translational movement along an axis, a transmitter may be provided, e.g. a tooth rack in rolling engagement with the adjustment wheel. Nevertheless, it should be worth mentioning that instead of such tooth rack, a slider in frictional rolling engagement with the adjustment wheel may be used or a bendable transmitter like a chain or a rope may be used.

When using such adjustment wheel having a rotation axis perpendicular to the desired adjusting movement, it is desired to combine preciseness of the adjustment with effectiveness and sufficient reach in terms of allowing sufficient adjustment of the comb by means of a limited rotatory movement of the adjustment wheel. For example, users usually do not want to need a plurality of revolutions of the adjustment wheel to move the distance comb from its closest position to its most distant position. On the other hand, some user wish to adjust the comb position in a very fine way to be able to choose between a two days' beard look and a three days' beard look.

### SUMMARY OF THE INVENTION

It is an objective underlying the present invention to provide for an improved hair cutter allowing for easy handling and precise control of adjustment of the comb position. More particularly, it is desired to allow precise control and easy handling with only one hand gripping the handle of the hair cutter without necessitating use of the second hand, wherein adjustments should be available even during haircutting.

Another objective of the present invention is to provide for a lightweight and space-saving design of the adjustment mechanism for adjusting the comb position to avoid interference with the support structure for slidably supporting an attached distance comb or restricting the design options for releasable attachment of the distance comb.

A still further objective underlying the invention is to create an improved adjustment mechanism combining precise and fine control of small adjustments with quick and efficient use of the entire adjustment range.

To achieve at least one of the aforementioned objectives, it is suggested to provide the adjustment mechanism with different transmission ratios to allow for fine adjustments with precise control on the basis of a first or small transmission ratio and on the other hand, quick and effective adjustment over a larger distance on the basis of a second or larger transmission ratio.

More particularly, the aforementioned adjustment wheel having a rotation axis substantially perpendicular to the desired direction of adjusting movement, and/or the transmitter for translating rotatory movement of the adjustment wheel into adjusting movements are configured to provide for at least two different transmission ratios for different rotatory positions of the adjustment wheel. Depending on the rotatory position of the adjustment wheel and/or depending on the comb position, adjustment of the comb position may be achieved with different transmission ratios.

More particularly, the adjustment wheel may be provided with a rotatory fine adjustment range having a fine transmission ratio and a rotatory quick adjustment range having a large transmission ratio that is larger than the fine transmission ratio so rotation of the adjustment wheel by a predetermined rotational distance generates different amounts of adjusting movements. More particularly, when rotating the adjustment wheel by a predetermined rotational distance within the aforementioned fine adjustment range, a relatively smaller adjustment of the comb position is generated whereas a comparatively larger adjustment distance of the comb position is generated when rotating the adjustment wheel by the same rotational distance in said quick adjustment range. While such two adjustment ranges may be sufficient, further adjustment ranges such as an intermediate adjustment range having a transmission ratio smaller than said large transmission ratio of the quick adjustment range and larger than said fine transmission ratio may be provided.

The aforementioned transmission ratios may be fixed or constant or non-variable within the associated adjustment range. More particularly, the large transmission ratio may be fixed and constant over the entire quick adjustment range and the fine transmission ratio may be fixed and constant over the entire fine adjustment range of the adjustment wheel. For example, the fine adjustment range may cover or correspond to a rotation of the adjustment wheel of about 90° and/or the quick adjustment range may cover or correspond to a rotation of about 270°. Within each of such ranges, the transmission ratio may be constant. Keeping the transmission ratios fixed over a certain range of rotation of the adjustment wheel gives the user confidence and control and allows intuitive use of the adjustment wheel, in contrast to continuously variable transmission ratios that tend to make users insecure as the transmission ratio changes every instant.

So as to achieve a compact, lightweight adjusting mechanism, the adjustment wheel may include wheel sections having different lever arms relative to the rotation axis, wherein such wheel sections of different lever arms may be formed in different sectors of the adjustment wheel positioned one after the other in the circumferential direction around the rotation axis, with a transitional portion being provided between such two sectors. Such wheel sections may be arranged in a common plane perpendicular to the rotation axis of the adjustment wheel or in the alternative, may be arranged in different planes each of which may be perpendicular to the rotation axis of the adjustment wheel. The transmitter may be configured to engage with both sections one after the other, depending on the rotatory position of the adjustment wheel and thus, depending on the adjustment position of the comb or comb holder.

These and other advantages become more apparent from the following description giving reference to the drawings and possible examples.

### BRIEF DESCRIPTION OF THE DRAWINGS

FIG. 1: a perspective front view of the handle of a hair cutter showing the position of an adjustment wheel for adjusting a composition on a front side of the handle, wherein the handle is shown with a cutter head having been removed,

FIG. 2: a perspective front view of the hair cutter of FIG. 1 with the cutter head mounted to the handle,

FIG. 3: a perspective front view of the hair cutter of FIG. 1 and FIG. 2 with a distance comb mounted onto the cutter head, wherein the distance comb is shown in a position close to the cutting elements of the cutter head,

FIG. 4: a perspective front view of the hair cutter similar to FIG. 3, wherein the distance comb is shown in a position more distant from the cutting elements than in FIG. 3,

FIG. 5: a side view of the hair cutter with the cutter head mounted to the handle similar to FIG. 2, wherein the side view shows a hook portion of a comb holder associated with a support structure for supporting the distance comb,

FIG. 6: a side view of the hair cutter similar to FIGS. 4 and 5 with the distance comb attached to the cutter head similar to FIG. 3, wherein the comb is shown in a position close to the cutting elements of the cutter head,

FIG. 7: a side view of the hair cutter similar to FIG. 6, wherein the distance comb is shown in a position further away from the cutting elements similar to FIG. 4,

FIG. 8: a plane view of the adjusting mechanism for adjusting the comb position, wherein the adjustment wheel is shown in engagement with the transmitter which includes the hook portions to be coupled with the comb and shown in FIG. 5,

FIG. 9: an enlarged partial view of the adjustment wheel in engagement with a transmitter frame having a side lack forming a toothed rack, wherein the adjustment wheel is shown to have two wheel sections having different pitch circle diameters and the toothed rack of the transmitter is shown to have toothings which are offset relative to each other in a direction perpendicular to a longitudinal axis of the tooth rack to engage with the adjustment wheel sections having different pitch circle diameters,

FIG. 10: an enlarged partial view of the adjustment wheel engaging the transmitter similar to FIG. 9, wherein the different sectors of the adjustment wheel are marked A, B, C and D,

FIG. 11: an enlarged partial view of the adjustment wheel engaging the transmitter similar to FIG. 10, wherein the geometry of the toothings of the toothed rack of the transmitter is indicated and marked,

FIG. 12: an enlarged partial view of the adjustment wheel engaging the transmitter similar to FIGS. 10 and 12, wherein the engagement overlap of the toothing of the transmitter with the teeth of the adjustment wheel is indicated as “a” and compared to a gap width between the circumferential contour of the adjustment wheel and an opposite side lack of the transmitter frame indicated by “b”,

FIG. 13: an enlarged partial view of the adjustment wheel engaging the transmitter, wherein specifics of the teeth of the toothed rack next to the transitional section between the two toothings of the toothed rack are indicated,

FIG. 14: a view of the adjustment wheel engaging the transmitter in a position within the fine adjustment range,

FIG. 15: a view of the adjustment wheel engaging the transmitter in a transitional position between the fine adjustment range and the quick adjustment range,

FIG. 16: a view of the adjustment wheel engaging the transmitter in a position in the quick adjustment range,

FIG. 17: a view of the adjustment wheel engaging the transmitter in an end position corresponding to a minimum distance of the distance comb,

FIG. 18: a view of the adjustment wheel engaging the transmitter in an end position corresponding to a maximum distance of the distance comb from the cutter head's cutting elements,

FIG. 19: a perspective, exploded view of the adjusting mechanism for adjusting the comb position, illustrating in addition to the transmitter frame and the adjustment wheel a latching/holding mechanism for holding the adjustment wheel and transmitter in desired set positions,

FIG. 20: a sectional view of the hair cutter showing a motor accommodated in the interior of the handle and a drive train for driving the cutting elements of the cutter head, and furthermore the adjustment mechanism for adjusting the position of the distance comb, and

FIG. 21: an enlarged sectional view of the cutter head and a part of the handle showing the motor and the drive train to the cutter elements of the cutter head and the adjustment wheel for adjusting the comb position.

### DETAILED DESCRIPTION OF THE INVENTION

So as to allow precise control and easy handling with only one hand gripping the handle even during haircutting and combining precise and fine control of small adjustments with quick and efficient use of the entire adjustment range, the adjustment mechanism is configure to provide for different transmission ratios to allow for fine adjustments with precise control on the basis of a first or small transmission ratio and on the other hand, quick and effective adjustment over a larger distance on the basis of a second or larger transmission ratio.

More particularly, the aforementioned adjustment wheel having a rotation axis substantially perpendicular to the desired direction of adjusting movement, and/or the transmitter for translating rotatory movement of the adjustment wheel into adjusting movements are configured to provide for different transmission ratios for different rotatory positions of the adjustment wheel. Depending on the rotatory position of the adjustment wheel and/or depending on the comb position, adjustment of the comb position may be achieved with different transmission ratios.

More particularly, the adjustment wheel may be provided with a rotatory fine adjustment range having a fine transmission ratio and a rotatory quick adjustment range having a large transmission ratio that is larger than the fine transmission ratio so rotation of the adjustment wheel by a predetermined rotational distance generates different amounts of adjusting movements. More particularly, when rotating the adjustment wheel by a predetermined rotational distance within the aforementioned fine adjustment range, a relatively smaller adjustment of the comb position is generated whereas a comparatively larger adjustment distance of the comb position is generated when rotating the adjustment wheel by the same rotational distance in said quick adjustment range.

The fine adjustment range is particularly helpful to control adjustments when the comb is rather close to the cutting elements whereas on the other hand the quick adjustment range is particularly helpful when the comb is further away from the cutting elements. Thus, the adjusting mechanism may be configured to have the fine adjustment range associated with comb positions next to or close to the combs minimum distance from the cutting elements and on the other hand, to have the quick adjustment range associated with comb positions next to or close to a maximum distance of the comb from the cutting elements. More particularly, the comb positions to be controllable under the fine adjustment range may be closer to the cutting elements than the comb positions controllable under the quick adjustment range.

The aforementioned transmission ratios may be fixed or constant or non-variable within the associated adjustment range. More particularly, the large transmission ratio may be fixed and constant over the entire quick adjustment range and the fine transmission ratio may be fixed and constant over the entire fine adjustment range of the adjustment wheel. For example, the fine adjustment range may cover or correspond to a rotation of the adjustment wheel of about 90° and/or the quick adjustment range may cover or correspond to a rotation of about 270°. Within each of such ranges, the transmission ratio may be constant. Keeping the transmission ratios fixed over a certain range of rotation of the adjustment wheel gives the user confidence and control and allows intuitive use of the adjustment wheel, in contrast to continuously variable transmission ratios that tend to make users insecure as the transmission ratio changes every instant.

So as to achieve a compact, lightweight adjusting mechanism, the adjustment wheel may include wheel sections having different lever arms relative to the rotation axis, wherein such wheel sections of different lever arms may be formed in different sectors of the adjustment wheel positioned one after the other in the circumferential direction around the rotation axis, with a transitional portion being provided between such two sectors. Said transitional portion forms a stepped portion and connects the wheel sections of different lever arms or wheel sections having different diameters. The transmitter may be configured to engage with both sections one after the other, depending on the rotatory position of the adjustment wheel and thus, depending on the adjustment position of the comb or comb holder.

Such wheel sections may be arranged in a common plane which is perpendicular to the wheels rotation axis. In other words, the adjustment wheel may have a substantially plate-like or planar shape with sections of different diameters. A section having a large diameter provides for a large lever arm and thus, for a large transmission ratio, whereas a section having a smaller diameter provides for a smaller lever arm and thus, for a smaller transmission ratio.

So as to allow engagement with such sections of different lever arms of the adjustment wheel, the transmitter could be, for example, an elastically tensioned chain able to engage with such different diameter sections of the adjustment wheel, or a belt guided in a way to allow engagement with the different sections of the adjustment wheel. However, said transmitter also may include a toothed rack or a friction rack in rolling engagement with the adjustment wheel, wherein such toothed rack or friction rack may include differently configured sections.

In particular, a toothed rack may have at least two toothing sections positioned one after the other in the direction of the longitudinal axis of the toothed rack, wherein said at least two tooth sections are offset relative to each other in a direction perpendicular to the rotation axis of the adjustment wheel and/or perpendicular to the longitudinal axis of the toothed rack. A toothing section closer to the rotation axis of the adjustment wheel may engage with the adjustment wheels section of smaller diameter, whereas the toothing section being positioned further away from the rotation axis may engage with the wheel's sections of larger diameter. In case of a friction rack, the rack may have at least two friction contours which are offset relative to each other in a corresponding way, i.e. one friction contour being closer to the rotation axis of the adjustment wheel than the other friction contour.

Nevertheless, some specific advantages such as a constantly precise correlation of the adjustment wheel's position to a desired comb position as slip between the adjustment wheel and the transmitter is prevented. Furthermore, no tensioning of the adjustment wheel against the transmitter is necessary, thereby avoiding complex support structures.

So as to achieve a smooth transition from adjustment wheel-transmitter-engagement providing large transmission ratio to adjustment wheel-transmitter-engagement providing small transmission ratio and vice versa, the toothings of the toothed rack may include teeth next to the transitional section of the toothed rack which teeth have a specific configuration that may be different from the remaining teeth's configuration.

In particular, a “last” tooth of the toothing that engages the adjustment wheel's section of small pitch circle diameter, i.e. the tooth next to the rack's transitional section may have an increased tooth height in comparison to the other teeth of this toothing section. Due to such increased tooth height, engagement with the adjustment wheel is ensured until the other toothing section of the rack gets into engagement with the adjustment wheel's section providing for a larger pitch circle diameter. In other words, engagement is ensured when the toothed racks transitional section between the two toothing sections of the rack faces the transitional section of the adjustment wheel between the wheel's sections of different lever arm and different pitch circle diameter.

In addition, or in the alternative to such increased height of the “last” tooth of the small transmission ratio toothing, a “last” tooth of the large transmission ratio toothing of the toothed rack may have a tooth tip provided with a beveling that is different from the tooth tips of the other teeth of this large transmission ratio toothing. In particular, the tooth neighboring the transitional section of the toothed rack may have a beveling at the tooth side facing the transitional section so as to allow save entry of the adjustment wheel's tooth of the large diameter section next to the transitional section into the recess of the toothed racks large transmission ratio toothing directly next to the transitional section.

The transmitter may include a transmitter frame that may include a pair of side legs positioned on opposite sides of the adjustment wheel, wherein said pair of side legs may be connected to each other by means of at least one cross frame element. Such transmitter frame is helpful to maintain engagement of the transmitter with the adjustment wheel without necessitating complex support of the adjustment wheel and the transmitter or use of highly rigid and stiff materials. In particular, one of said side legs may be in rolling engagement with the adjustment wheel and more particularly, may include the aforementioned toothings forming a toothed rack engaging with the toothings of the adjustment wheel.

The other side leg of the transmitter frame may form a guiding element or a guiding contour that is spaced apart from the adjustment wheel by a substantially constant gap when said transmitter moves relative to the adjustment wheel so as to prevent movements of the transmitter frame transverse to the adjusting movement and to keep the other or toothed side leg in rolling engagement with the adjustment wheel. The small gap is provided so as to avoid friction, wherein such gap may be very small, for example less than 1 mm or less than 0.5 mm to prevent any significant transverse movement of the other side leg away from the adjustment wheel.

More particularly, said gap may have a gap width that is smaller than the engagement depth or overlap of the toothings of the toothed rack and the adjustment wheel engaging with each other. Thus, due to such gap width being smaller than the teeth overlap, constant and reliable engagement may be ensured even when the adjustment wheel and/or the transmitter show tolerances or the support of said elements allow for some play as the adjustment wheel is locked or constrained in the transmitter frame's space between the two side legs thereof, in the transverse direction. On the one side, the engaging toothings constrain transverse movement and on the other side, the other side leg of the transmitter frame and the facing circumferential section of the adjustment wheel constrains transverse movements to the other side.

In particular, the guiding contour on the other side leg may have a curved contour or may form a curved trajectory following the circumferential contour of the adjustment wheel having different diameters and different sections when said adjustment wheel is rotated.

So as to achieve precise control and to avoid play, the adjustment train may consist of only two elements forming the drive train that transmits driving forces and driving action from the adjustment wheel to the distance comb or comb holder, wherein said two elements are the adjustment wheel and the transmitter.

Nevertheless, the adjustment mechanism may include further elements such as a latching mechanism for holding the adjustment wheel in a plurality of desired positions. Nevertheless, the torque applied by fingers of a user to the adjustment wheel is directly translated into displacement of the comb by means of only said aforementioned two elements.

Furthermore, the comb holder to which the distance comb may be attached fixedly or releasably, may be formed integrally with the transmitter in one piece. For example, the comb holder may include two projecting arms fixedly attached to the aforementioned transmitter frame and projecting, for example, from the two side legs thereof.

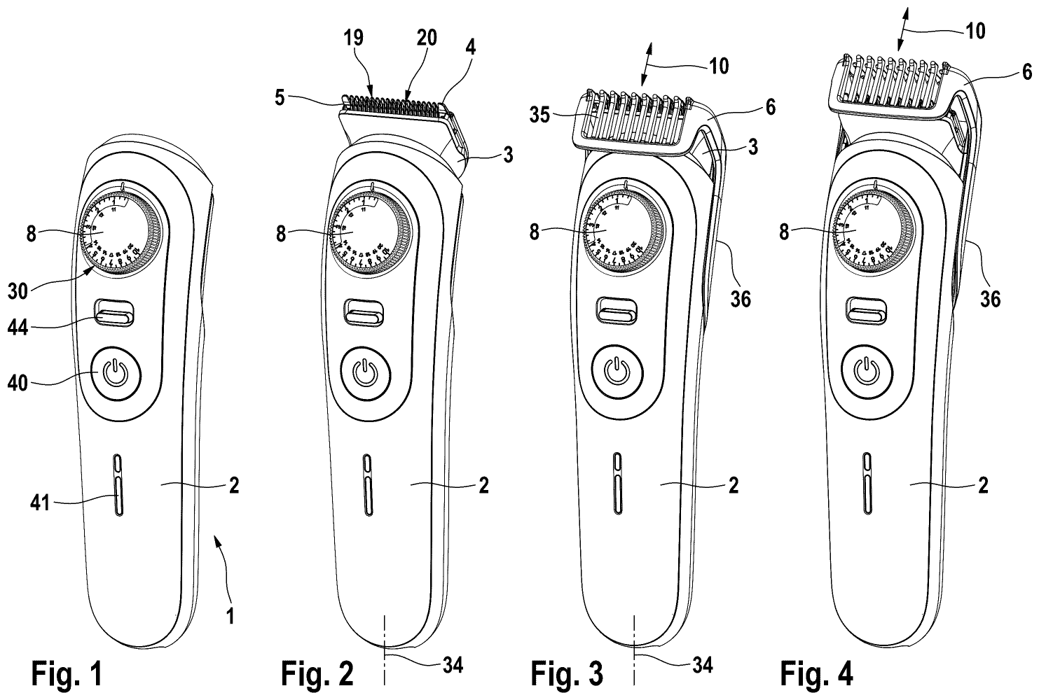

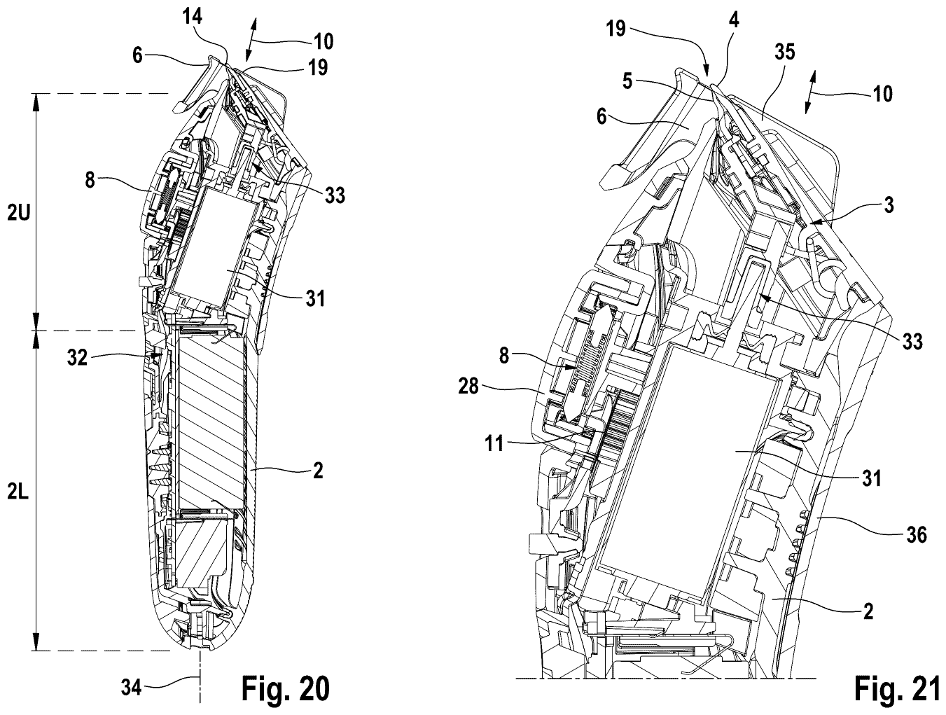

As can be seen from FIGS. 1 to 4, a cutter head 3 may be attached to a handle 2 of a shaver and/or trimmer 1. More particularly, the shaver and/or trimmer 1 may include an elongated handle 2 accommodating the electronic and/or electric components such as a control unit 32, an electric or a magnetic drive motor 31 and a drive train 33 for transmitting the driving action of the motor to the cutter system 19 of the cutter head 3 which cutter head 3 may be positioned at one end of the elongated handle 2, cf. FIG. 20 and FIG. 21

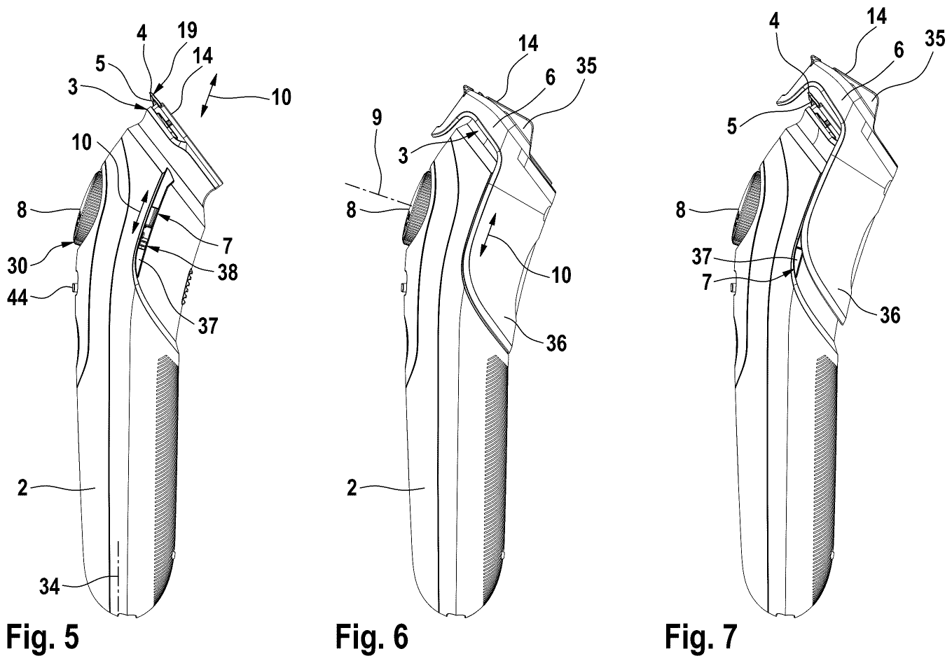

The elongated handle 2 may be straight or may have a swan-necked or slightly cranked or angulate upper end portion 2U in which said drive motor 31 may be accommodated or at which said cutter head 3 is supported, which upper end portion 2U may be cranked relative to a lower gripping portion 2L at an acute angle, cf. FIGS. 5 to 7 and 20. More particularly, the drive motor 31 on the one hand and the control unit 32 and/or a battery/accumulator 32B for powering the drive motor 31 may be arranged in an angulate manner relative to each other in said swan-necked handle portions 2U and 2L, cf. FIG. 20. Alternatively, the elongate handle may be wider than longer.

The cutter system 19 may include a pair of cooperating cutter blades 4 and 5 may be the only cutter system of the cutter head 3 as it is the case with the example shown in FIG. 2. On the other hand, the cutter system 19 may be incorporated into a trimmer head 3 having other cutter systems such as shear foil cutters, wherein, for example, the cutter system 19 having at least one row 20 of cooperating cutting teeth may be positioned along an edge portion of a shear foil cutter.

Said row 20 of cutting teeth may reciprocate relative to each other along a linear path so as to effect the cutting action by closing the gaps between the teeth and passing over each other. On the other hand, the cutter system 3 also may include cutting teeth which are aligned along a circle and/or are arranged radially. Such rotatory cutting elements may have cutting teeth projecting substantially radially, wherein the cutting elements may be driven to rotate relative to each other and/or to rotatorily oscillate relative to each other. The cutting action is basically similar to reciprocating cutting elements as the radially extending teeth, when rotating and/or rotatorily oscillating, cyclically close and reopen the gap between neighboring teeth and pass over each other like a scissor.

The outer/upper one of said cutting elements 4, 5 may itself define a skin contact surface 14 at a forward end portion of the cutter head 3, when using the hair cutter 1 without protection or distance comb 6, cf. FIG. 2 and FIG. 5.

On the other hand, when a distance comb 6 is attached to the cutter head 3, it is not the upper/outer cutting element itself, but such distance comb 6 which defines the skin contact surface 14 of the cutter system, cf. FIGS. 3 and 6. More particularly, the surface of the distance comb 6 facing away from the handle 2 or from the cutting elements 4, 5 may define the skin contact surface 14, cf. FIGS. 6 and 7.

As can be seen from a comparison of FIGS. 3 and 4 and furthermore, FIGS. 6 and 7, said distance comb 6 is variable in terms of its position relative to the cutter head 3. More particularly, said distance comb 6 may be displaced in an adjusting direction 10 that is substantially perpendicular to the aforementioned skin contact surface 14, wherein such adjusting direction 10 is slightly inclined, at an acute angle, to the longitudinal axis 34 of handle 2.

More particularly, said direction 10 of adjusting the comb 6 may be substantially parallel to the portion of the swan-necked longitudinal axis 34 along which the swan-necked upper end portion of the handle 2 is extending, cf. FIGS. 5, 6 and 20. Irrespective of such swan-necked configuration of the handle 2, the adjustment direction 10 may be substantially parallel to the motor axis of drive motor 31, cf. FIG. 20.

Such adjustability of the distance comb 6 allows to vary the distance of the skin contact surface 14 defined by the distance comb 6 from the cutting elements 4, 5 of the cutter head 3.

The distance comb 6 may include a plurality of ribs 35 between which hair to be cut can be inserted to reach the cutting elements 4, 5. By means of adjusting the distance of the skin contact surface 14 defined by the comb 6 from said cutting elements 4, 5, the length of the hair remaining uncut can be adjusted.

As can be seen from FIGS. 6 and 7 and the cross-sectional view of FIG. 20, said distance comb 6 may form a sort of hoot or cap that can be put onto the cutter head 3, wherein the comb 6 may include a supporting skirt 36 and compassing an upper end portion of the handle 2, wherein such supporting skirt may have a half-shell shape, cf. FIG. 6.

The handle 2 may include a sliding support structure for slidably supporting said comb 6 to allow translational displacement thereof in the aforementioned adjusting direction 10. More particularly, an outer surface of the handle 2 may include a guiding rail or guiding slot 37 in which bearing protrusions of the distance comb 6 may be slidably received, cf. FIG. 5.

In the alternative, it would be possible to provide the guiding slot in the distance comb 6, in particular the skirt 36 and to have bearing protrusions on an outer surface of the handle 2. Nevertheless, to improve handling when using the hair cutter 1 without comb 6, it is preferred to provide for guiding slots 37 in the handle 2.

In particular, a plurality of such guiding slots 37 may be provided at the handle 2, wherein such guiding slots may be arranged parallel to each other and distributed and spaced apart from each other in a circumferential direction. In particular, a pair of guiding slots 37 may be provided on opposite sides of the handle 2, cf. FIG. 5.

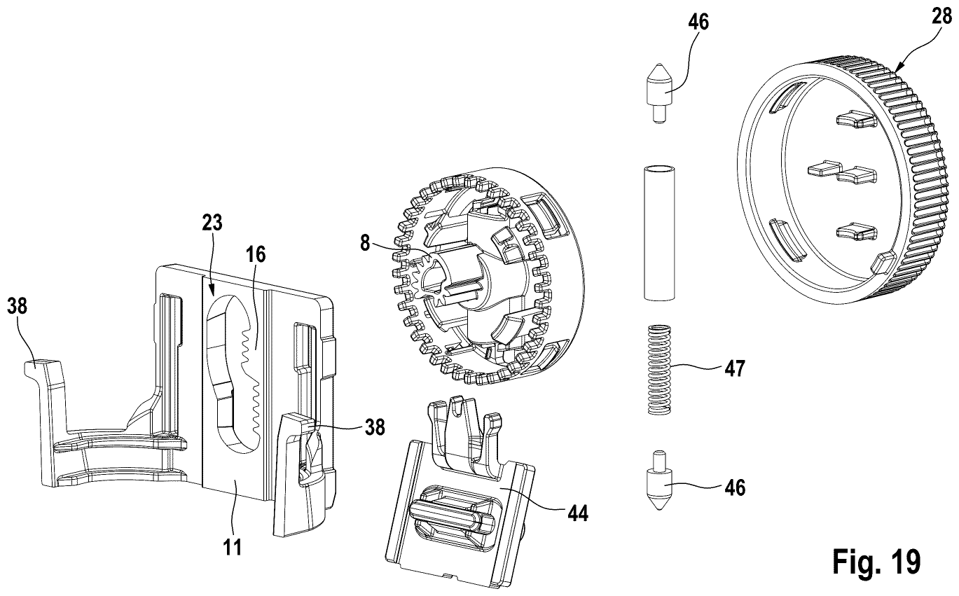

As it is indicated by FIGS. 5 and 19, driving elements 38 may be associated with the aforementioned support structure for slidably supporting the distance comb 6, wherein such driving elements 38 may be engaged with or fixed to the distance comb 6. For example, driving pins or hooks may be provided which may be engaged with corresponding recesses in the distance comb 6.

As FIG. 5 indicates, such driving elements 38 may include driving protrusions slidably received in or protruding from the aforementioned guiding slots 37, wherein said driving elements 38 may be engaged with corresponding portions of the skirt 36 of the distance comb 6.

As shown by FIGS. 5 to 7, said driving elements 38 may be moved up and down along the guiding slots 37 what makes the distance comb 6 move up and down to vary the distance of the distance comb 6 from the cutting elements 4, 5.

FIG. 6 shows the distance comb 6 in a position of minimum distance from the cutting elements 4, 5, whereas FIG. 7 shows a position of the distance comb 6 of maximum distance from said cutting elements 4, 5.

So as to adjust the position of the distance comb 6, the aforementioned driving elements 38 form part of an adjustment mechanism 39 which includes an adjustment wheel 8 that is positioned on an outer surface of the handle 2, in particular in a region close to the cutter head 3, wherein such adjustment wheel 8 may be oriented in a plane substantially tangential to the outer surface of the handle 2.

More particularly, said adjustment wheel 8 may be rotatably supported at the handle 2 about a rotation axis 9 which extends perpendicular to the aforementioned adjusting direction 10 and/or substantially parallel to the skin contact surface 14 and/or substantially perpendicular to a portion of the outer surface of the handle 2 where the adjustment wheel 8 is mounted.

In particular, the adjustment wheel 8 may be positioned on a front side of the handle 2 which front side may be provided with other control elements or operation elements such as an on-/off-switch 40 and/or a display 41 which may indicate relevant hair cutter information to a user, for example the loading status of batteries.

As shown by FIGS. 3 and 6, the adjustment wheel 8 may be positioned on a side of the handle 2 which is opposite to the skirt 36 of the distance comb 6.

Such skirt 36 may fulfill a double function: On the one hand it is supporting the distance comb 6 in a slidable way as described. In addition, it is a helpful indicator of the comb's position. In particular, as the skirt 36 is on the opposite side of the adjustment wheel 8, a user easily sees the skirt 36 and thus, the comb 6 moves when the adjustment wheel 8 is rotated. The user will more precisely see the comb position on the comb wheel's scale printing.

Alternatively, the wheel 8 and all mechanical parts needed to adjust the comb in the desired distance position relative to the cutters, so including e.g. the transmitter, may be part of the adjustable distance comb itself and not part of the handle.

As shown in the FIGS. 1-4, the handle is connectable with different cutter heads 3 and different combs may be attached to the handle with connected cutter head. Alternatively, the cutter head 3 may be integral, so non-exchangeable with the handle connected and only the comb attachments may be exchangeable. In both variants, the adjustable distance comb shown in the figures may be exchanged by other, e.g. fixed combs or special purpose combs, like sensitive area combs.

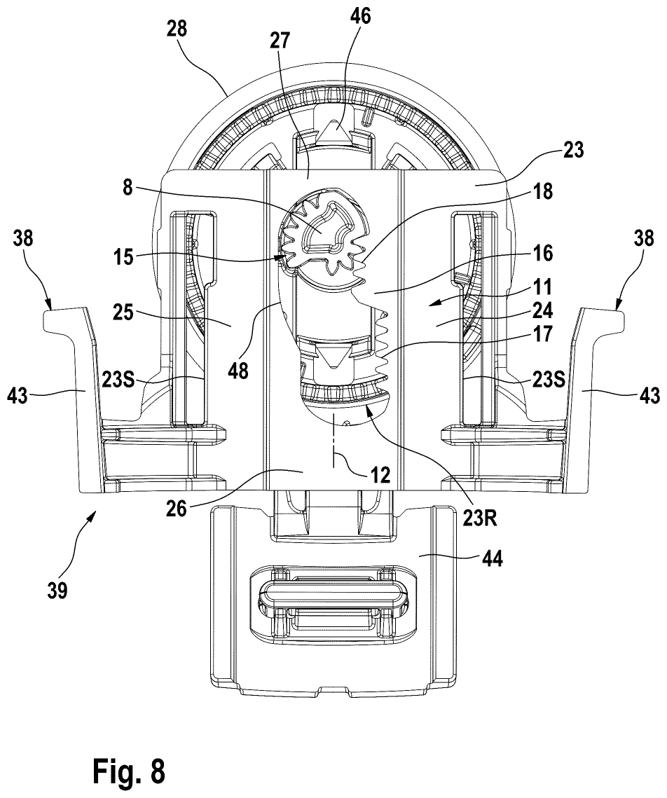

As can be seen from FIGS. 8, 9 and 19, the adjustment wheel 8 may be rigidly connected to or integrally formed with a control nob 30 in one piece, wherein it is actually said control nob 30 which is positioned on the outer surface of the handle 2. The adjustment wheel 8, which is in driving engagement with a transmitter 11, may be positioned in the interior of the handle 2, cf. FIG. 20 and FIG. 21. The handle 2 may include a recessed portion in which the control nob 30 may be received or at least partly counter-sunk, wherein a bottom wall portion of said recess may include a through hole through which the adjustment wheel 8 may be inserted to be positioned in the interior of handle 2, cf. FIG. 21.

The transmitter 11 which is driven by said adjustment wheel 8, includes a toothed rack 16 which is in rolling engagement with an outer circumference of the adjustment wheel 8. More particularly, the toothed rack 16 includes toothings 17, 18 which may mesh with a toothing 15 on the outer circumferential portion of the adjustment wheel 8, cf. FIG. 8.

When the adjustment wheel 8 is rotated, such rotatory movement is translated into a sliding movement of the toothed rack 16 due to the meshing or rolling engagement of the adjustment wheel's toothing 15 with the toothings 17, 18 of the toothed rack 16.

Said toothed rack 16 is slidably supported on, for example, an interior side of the handle 2 or a support frame structure received in the interior of said handle 2. For example, the motor 31 may be mounted on a support cage that also may support said toothed rack 16.

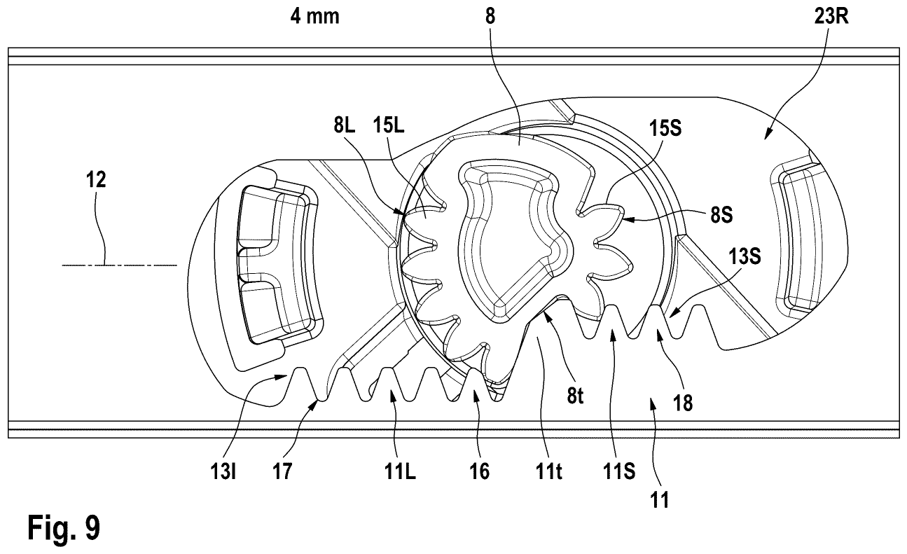

Said toothed rack 16 may be part of a transmitter frame 23 comprising two side legs 24 and 25 which are connected to each other by cross connectors 26, 27 so such transmitter frame 23 is provided with a central recess 23R in which said adjustment wheel 8 is received, cf. FIG. 8 and FIG. 9.

The transmitter frame 23 is slidably supported for translational movement along the adjusting direction 10, wherein such translational movement may be the only degree of freedom for the transmitter frame 23.

As illustrated by FIG. 8, the transmitter frame 23 may further include the aforementioned driving elements 38 which may engage the skirt 36 of the distance comb 6. For example, the driving elements 28 may be hooks or pins supported on elastic support arms 43 to allow for automatic engagement or latching of the driving elements 38 with the distance comb 6 when said distance comb 6 is attached onto the cutter head 3 and/or the upper portion of the handle 2 such that the supporting portions of the skirt 36 enter into the guiding slots 37 in which the hooks on the support arms 43 are positioned.

As illustrated by FIG. 8 and FIG. 19, rotation of the adjustment wheel 8 may be blocked by means of a stopper 44. Such stopper 44 may include a slider that is slidably supported in a direction radial to the rotation axis 9 of the adjustment wheel 8. For example, the control nob 30 may be provided with a toothed structure 45 along a circumferential surface. When the stopper 44 is moved against the control nob 28 and/or against adjustment wheel 8, it may engage with such toothed structure 45 so rotation is blocked. On the other hand, when the slider or stopper 44 is removed from the adjustment wheel 8, the toothed structure 45 gets out of engagement from the stopper 44 and thus, rotation of the adjustment wheel 8 becomes possible.

In addition, or in the alternative to such stopper 44, a breaking or holding mechanism 46 is provided for holding the attachment wheel 8 in various desired rotational positions. For example, such holding mechanism or breaking mechanism 45 may include a biased latch 46 that is urged, by means of a spring 47 towards a latching position in which said latch 46 catches a complementary contour of the adjustment wheel 8. Preferably, the biasing of the latch 46 is configured such that applying a sufficiently high torque onto the control nob 30 may overcome the breaking or holding forces of the holding mechanism 45.

The adjusting mechanism 39 is configured to provide for two different transmission ratios. More particularly, the adjustment wheel 8 and the transmitter 11 are configured to cooperate such that in different rotational positions of the adjustment wheel 8, rotatory movements of the adjustment wheel 8 are translated into sliding of the transmitter 11 on the basis of a larger transmission ratio or a smaller transmission ratio.

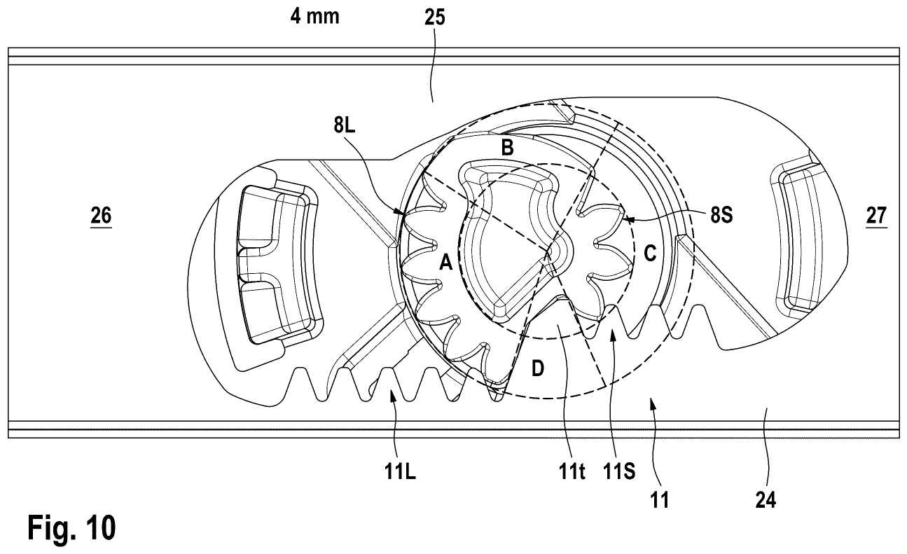

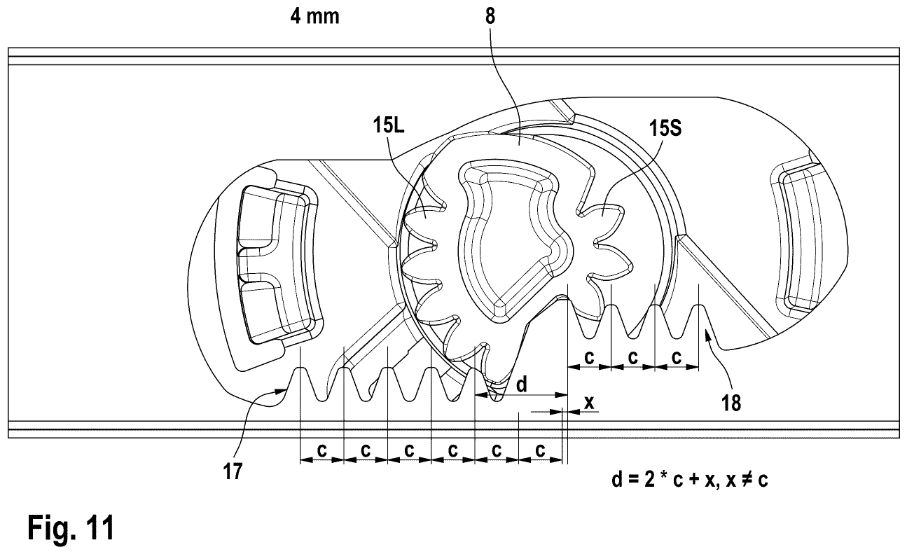

As shown by FIGS. 8 to 18, the adjustment wheel 8 may include wheel sections 8L, 8S having different lever arms relative to the rotation axis 9, wherein such wheel sections 8L, 8S of different lever arms may be formed in different sectors of the adjustment wheel 8 positioned one after the other in the circumferential direction around the rotation axis 9, with a transitional portion 8t being provided between such two sectors.

Said transitional portion 8t forms a stepped portion and connects the wheel sections 8L, 8s of different lever arms or wheel sections having different diameters.

The transmitter 11 may be configured to engage with both sections 8L, 8S one after the other, depending on the rotatory position of the adjustment wheel 8 and thus, depending on the adjustment position of the comb or comb holder.

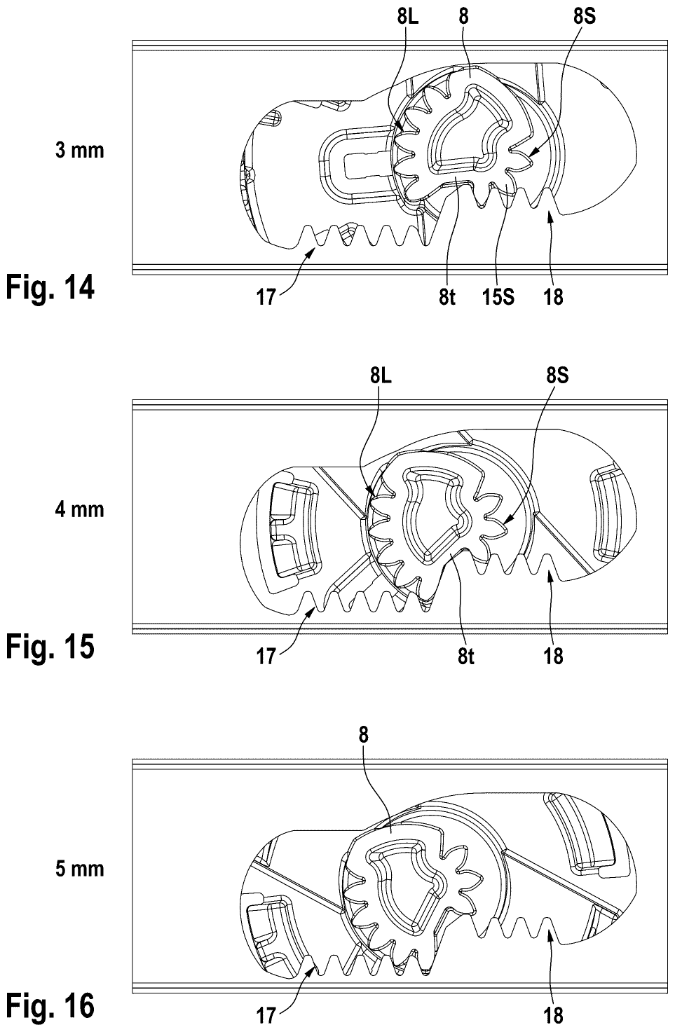

FIGS. 14 to 18 illustrate such engagement of the transmitter 11 with said different sections 8L, 8S of the adjustment wheel 8, wherein FIG. 15 shows the transition from engagement of the small lever arm section 8S of adjustment wheel, as illustrated in FIG. 14, to engagement of the large lever arm section 8L, as illustrated further in FIGS. 16 and 18.

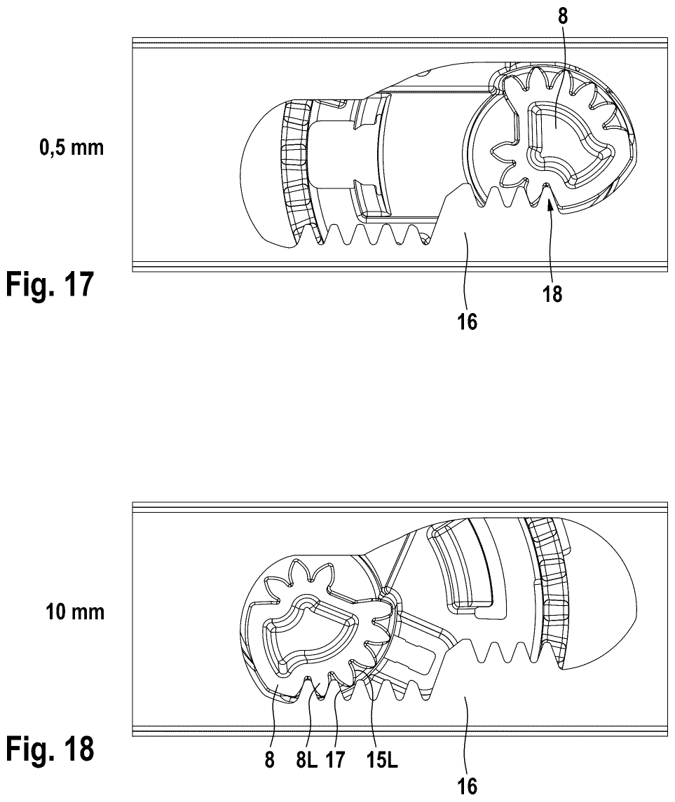

FIGS. 17 and 18 show the rotatory end positions of the adjustment wheel 8 corresponding to a comb position of minimum distance from the cutting elements 4, 5, cf. FIG. 17, and a comb position of maximum distance from the cutting elements 4, 5, cf. FIG. 18.

Said wheel sections 8L, 8t and 8S of the adjustment wheel 8 are arranged in a common plane which is perpendicular to the wheel's rotation axis 9. In other words, the adjustment wheel 8 may have a substantially plate-like or planar shape with sections of different diameters. The section 8L having a large diameter provides for a large lever arm and thus, for a large transmission ratio, whereas section 8S having a smaller diameter provides for a smaller lever arm and thus, for a smaller transmission ratio.

So as to allow engagement with such sections 8L, 8S of different lever arms of the adjustment wheel 8, the transmitter 11 includes a toothed rack 16 in rolling, meshing engagement with the adjustment wheel 8, wherein such toothed rack 16 includes differently configured sections 11L, 11t and 11S.

In particular, the toothed rack may have at least two toothing sections 17, 18 positioned one after the other in the direction of the longitudinal axis of the toothed rack 16, wherein said at least two tooth sections 17, 18 are offset relative to each other in a direction perpendicular to the rotation axis 9 of the adjustment wheel 8 and/or perpendicular to the longitudinal axis of the toothed rack 16.

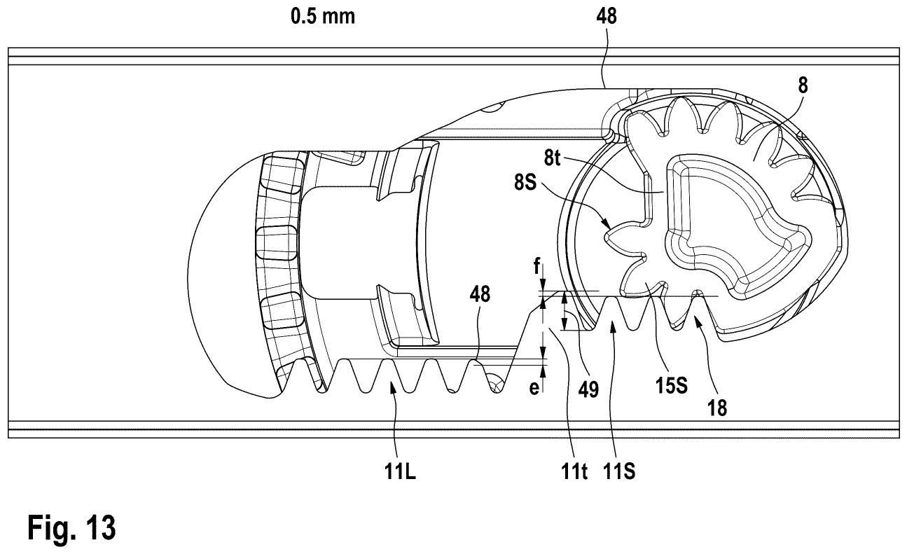

A toothing section 18 closer to the rotation axis 9 of the adjustment wheel 8 may engage with the adjustment wheel's section 8S of smaller diameter, cf. FIGS. 13 and 14, whereas the toothing section 17 being positioned further away from the rotation axis 9 may engage with the wheel's section 8L of larger diameter, cf. FIGS. 16 and 18.

So as to achieve a smooth transition from the large transmission ratio to the small transmission ratio and vice versa, the toothings 17, 18 of the toothed rack 16, may include teeth next to the transitional section 11t of the toothed rack 16 which teeth have a specific configuration that may be different from the remaining teeth's configuration.

In particular, a “last” tooth of the toothing 18 that engages the adjustment wheel's section 8S of small pitch circle diameter, i.e. the tooth next to the rack's transitional section 11t may have an increased tooth height 49, cf. FIG. 13, in comparison to the other teeth of this toothing section 18. Due to such increased tooth height 49, engagement with the adjustment wheel 8 is ensured until the other toothing section 17 of the rack 16 gets into engagement with the adjustment wheel's section 8L providing for a larger pitch circle diameter. In other words, engagement is ensured over transition from one transmission ratio to the other transmission ratio, i.e. when the toothed rack's transitional section 11t between the two toothing sections 17, 18 of the rack 16 faces the transitional section 8t of the adjustment wheel 8 between the wheel's sections 8L, 8S of different lever arm and different pitch circle diameter, as it is shown by FIGS. 9, 10 and 11.

In addition, or in the alternative to such increased height 49 of the “last” tooth of the small transmission ratio toothing 18, a “last” tooth of the large transmission ratio toothing 17 of the toothed rack 16 may have a tooth tip provided with a beveling 48 that is different from the tooth tips of the other teeth of this large transmission ratio toothing, cf. FIG. 13.

In particular, the tooth neighboring the transitional section 11t of the toothed rack 16 may have a beveling 48 at the tooth side facing the transitional section 11t so as to allow save entry of the adjustment wheel's tooth of the large diameter section 8L next to the transitional section 8t into the recess of the toothed rack's large transmission ratio toothing 17 directly next to the transitional section 11t, cf. FIG. 13.

As mentioned, the transmitter 11 may include a transmitter frame 23 that include a pair of side legs 24, 25 positioned on opposite sides of the adjustment wheel 8, cf. FIG. 8, wherein said pair of side legs 24, 25 are connected to each other by means of cross frame elements 26, 27. Such transmitter frame 23 is helpful to maintain engagement of the transmitter 11 with the adjustment wheel 8 without necessitating complex support of the adjustment wheel 8 and the transmitter 11 or use of highly rigid and stiff materials. For example, the adjustment wheel 8 and the transmitter 11 may be made from plastic.

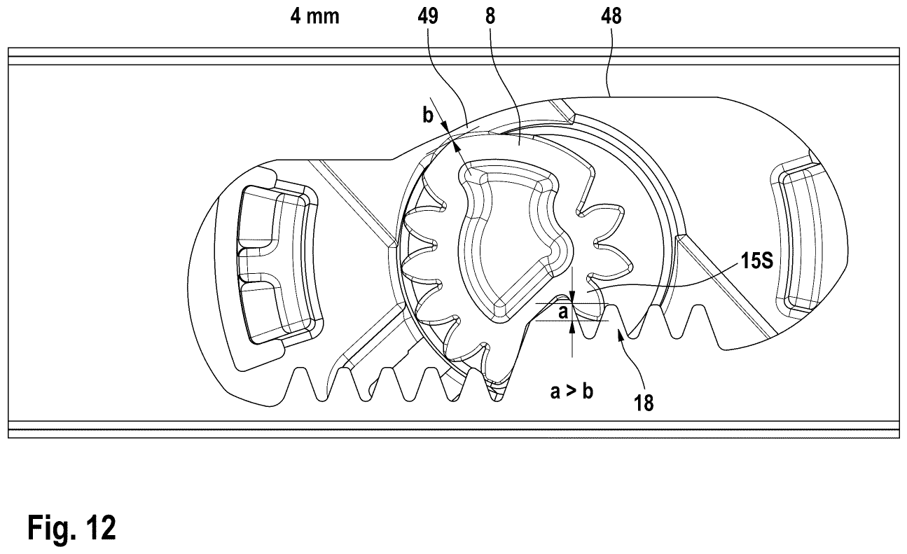

In particular, one of said side legs 24 includes the aforementioned toothings 17, 18 and the other side leg 25 of the transmitter frame 23 forms a guiding element or a guiding contour 48 that is spaced apart from the adjustment wheel 8 by a substantially constant gap 50, cf. FIG. 12, when said transmitter 11 moves relative to the adjustment wheel 8, cf. FIGS. 14 to 18 o as to prevent movements of the transmitter frame 23 transverse to the adjusting movement 10 and to keep the other or toothed side leg 24 in rolling engagement with the adjustment wheel 8. The small gap 50 is provided so as to avoid friction, wherein such gap 50 may be very small, for example less than 1 mm or less than 0.5 mm to prevent any significant transverse movement of the other side leg away from the adjustment wheel.

More particularly, said gap may have a gap width “b” that is smaller than the engagement depth “a” or overlap of the toothings 17, 18 and 15 of the toothed rack 16 and the adjustment wheel 8, respectively, engaging with each other, cf. FIG. 12.

Thus, due to such gap width “b” being smaller than the teeth overlap “a”, constant and reliable engagement may be ensured even when the adjustment wheel 8 and/or the transmitter 11 show tolerances or the support of said elements allow for some play as the adjustment wheel 8 is locked or constrained in the transmitter frame's space between the two side legs 24, 25 thereof, in the transverse direction.

In particular, the guiding contour 48 on the other side leg 25 may have a curved contour or may form a curved trajectory following the circumferential contour of the adjustment wheel 8 having different diameters and different sections when said adjustment wheel 8 is rotated, cf. FIGS. 8 to 18 in comparison to each other showing different portions of the guiding contour 48 directly facing different sections of the circumference of the adjustment wheel 8, wherein the gap width “b” remains substantially constant despite the diameter steps of adjustment wheel 8.

As can be seen from FIGS. 9 to 11, the side leg 24 in rolling engagement with said adjustment wheel 8 includes at least two engagement portions which may include the toothings 17, 18 extending parallel to each other and offset relative to each other, in a step-like manner, in a direction transverse to the rotation axis 9 of the adjustment wheel 8. The other side leg 25 forming the guiding contour 48 is opposite to each of said at least two engagement portions or toothings 17, 18 wherein the guiding contour 48 may have a curved guiding contour section opposite to, in a direction perpendicular to the sliding direction of the transmitter 11, a step-like transitional portion between said at least two engagement portions or toothings 17, 18, wherein said two side legs 24, 25 of the transmitter frame 23 define a central transmitter frame recess 23R accommodating the adjustment wheel 8 snuggly fitting between said two side legs 24, 25 in all adjustment positions of said transmitter 11, cf. FIGS. 9 to 11 in combination with each other.

Furthermore, said side legs 24, 25 may include supporting contours 23S for slidably supporting said transmitter frame 23 at said handle 2 and/or at a motor support structure received in said handle 2, wherein said supporting contours 23S are parallel to each other and parallel to said direction 10 of adjusting the comb position. Said supporting contours may be arranged outwardly from said guiding contour 48 and said toothings 17, 18, cf. FIG. 8.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. Hair cutter such as a trimmer, comprising an elongated handle, a cutter head attached to an end portion of said handle and including at least one cutting element, and a comb support structure for supporting a distance comb, wherein an adjustment wheel is provided for adjusting a position of said distance comb relative to said at least one cutting element, said adjustment wheel being rotatably supported about a rotation axis extending transverse to a direction of adjusting the comb position, wherein a transmitter is provided for translating rotatory movement of said adjustment wheel into adjusting movements, wherein said adjustment wheel or said transmitter are configured to provide for different transmission ratios for different rotatory positions of the adjustment wheel or said adjustment wheel and said transmitter are configured to provide for different transmission ratios for different rotatory positions of the adjustment wheel.

2. Hair cutter according to claim 1, wherein said adjustment wheel is provided with a rotatory fine adjustment range having a fixed, non-variable fine transmission ratio and a rotatory quick adjustment range having a fixed, non-variable large transmission ratio larger than the fixed fine transmission ratio so rotation of the adjustment wheel by a predetermined rotational distance within the rotatory fine adjustment range generates a smaller adjustment of the comb position than rotation of the adjustment wheel by the same rotational distance in said quick adjustment range, wherein said rotatory fine adjustment range is associated with a first range of comb positions and said rotatory quick adjustment range is associated with a second range of comb positions, wherein said first range of comb positions provides for comb positions closer to the at least one cutting element than said second range of comb positions.

3. Hair cutter according to claim 1, wherein said adjustment wheel and said transmitter are separate from the distance comb and are provided at said handle, wherein said adjustment wheel includes a manual operation portion or control knob positioned on an exterior side of the handle for manual adjustment of the distance comb and an engagement portion or toothing in the interior of said handle for engagement with the transmitter positioned in the interior of said handle.

4. Hair cutter according to claim 1, wherein said adjustment wheel includes wheel sections of different lever arms relative to the rotation axis of the adjustment wheel, each of said wheel sections configured for engagement with said transmitter.

5. Hair cutter according to claim 1, wherein said wheel sections of different lever arms form different sectors of the adjustment wheel which sectors are positioned in a common plane and, in the circumferential direction around the rotation axis, one after the other with a transitional portion of the adjustment wheel being provided between each pair of neighboring sectors.

6. Hair cutter according to claim 5, wherein each of said wheel sections of the adjustment wheel provides for a constant lever arm.

7. Hair cutter according to claim 1, wherein said transmitter is supported slidably along a transmitter axis parallel to said direction of adjusting the comb position or tangential to a circumferential direction of said adjustment wheel, wherein said transmitter is provided with transmitter sections positioned one after the other along said transmitter axis with a transitional section being provided between said transmitter sections, wherein said transmitter sections have engagement contours for rolling engagement with said adjustment wheel which engagement contours are, in comparison to each other, differently spaced apart from the rotation axis of the adjustment wheel or have a different height relative to said transmitter axis.

8. Hair cutter according to claim 1, wherein said adjustment wheel is provided with toothings defining different pitch circle diameters including a large pitch circle diameter and a small pitch circle diameter, each of said toothings being engageable with said transmitter to provide for different transmission ratios.

9. Hair cutter according to claim 8, wherein said transmitter includes a tooth rack having toothings offset relative to each other in a direction perpendicular to a longitudinal axis of the tooth rack.

10. Hair cutter according to claim 9, wherein at least one of said toothings includes a transitional tooth next to said transitional section of said transmitter, which transitional tooth has a contour different from the other teeth of said at least one toothing, said different contour including a different tooth height or a tooth tip beveling.

11. Hair cutter according to claim 1, wherein said transmitter includes a transmitter frame including a pair of side legs connected to each other by at least one cross-connector, said side legs being arranged on opposite sides of said adjustment wheel, wherein one of said side legs is in rolling engagement with said adjustment wheel and the other one of said side legs forms a guiding contour spaced apart from said adjustment wheel by a constant gap when said transmitter moves relative to said adjustment wheel to prevent movements of the transmitter frame transverse to the adjusting movements and keep said side leg in rolling engagement with the adjustment wheel.

12. Hair cutter according to claim 11, wherein said guiding contour forms a curved trajectory following the circumferential contour of the adjustment wheel having different diameters in different sections.

13. Hair cutter according to claim 11, wherein said side leg in rolling engagement with said adjustment wheel includes at least two engagement portions or toothings extending parallel to each other and offset relative to each other in a direction transverse to the rotation axis of the adjustment wheel, and wherein said other side leg forming the guiding contour is opposite to each of said at least two engagement portions or toothings with the guiding contour having a curved guiding contour section opposite to a step-like transitional portion between said at least two engagement portions or toothings, wherein said two side legs of the transmitter frame define a central transmitter frame recess accommodating the adjustment wheel snuggly fitting between said two side legs in all adjustment positions of said transmitter.

14. Hair cutter according to claim 11, wherein said side legs include supporting contours for slidably supporting said transmitter frame at said handle or at a motor support structure received in said handle which supporting contours are parallel to each other and parallel to said direction of adjusting the comb position.

15. Hair cutter according to claim 1, wherein said adjustment wheel and said transmitter together form a drivetrain for driving a comb holder to which said distance comb is permanently or releasably fixed, wherein said drivetrain consists of two train pieces which train pieces are formed by said adjustment wheel and said transmitter.

16. Hair cutter according to claim 15, wherein said comb holder is integrally formed with said transmitter in one piece.
